(19) United States
(12) Patent Application Publication
(10) Pub. No.: US 2014/0154009 A1
(43) Pub. Date: Jun. 5, 2014

(54) ASPHALT COMPOSITION

(71) Applicants: Sunil Ashtekar, Bangalore (IN); Franciscus Gondulfus Anton Van Den Berg, Amsterdam (NL); Majid Jamshed Chughtai, Chester (GB); Marinus Johannes Reynhout, Amsterdam (NL); Govind Wagle, Bangalore (IN)

(72) Inventors: Sunil Ashtekar, Bangalore (IN); Franciscus Gondulfus Anton Van Den Berg, Amsterdam (NL); Majid Jamshed Chughtai, Chester (GB); Marinus Johannes Reynhout, Amsterdam (NL); Govind Wagle, Bangalore (IN)

(21) Appl. No.: 14/119,257

(22) PCT Filed: May 23, 2012
(86) PCT No.: PCT/EP2012/059645

§ 371 Date: Jan. 29, 2014

(30) Foreign Application Priority Data
May 25, 2011 (IN) PCT/IN2011/000363

(51) Int. Cl. C08K 3/30; E01C 19/48; C08L 95/00

(52) U.S. Cl. CPC C08K 3/30; C08L 95/00; E01C 19/48
USPC 404/72; 106/274; 106/233; 106/269; 106/316; 404/79

(57) ABSTRACT

An asphalt composition comprising aggregate, bitumen, sulphur and an anionic surfactant is disclosed, wherein the amount of anionic surfactant is from 0.05 wt % to 10 wt %, based upon the weight of the sulphur. Methods of preparing asphalt compositions and asphalt pavements are also disclosed.

### FIELD OF THE INVENTION

The invention relates to an asphalt composition and a process for the manufacture of an asphalt composition.

### BACKGROUND OF THE INVENTION

In the road construction and road paving industry, it is a well-practised procedure to coat aggregate material such as sand, gravel, crushed stone or mixtures thereof with hot fluid bitumen, spread the coated material as a uniform layer on a road bed or previously built road while it is still hot, and compact the uniform layer by rolling with heavy rollers to form a smooth surfaced road.

The combination of bitumen with aggregate material, such as sand, gravel, crushed stone or mixtures thereof, is referred to as “asphalt”. Bitumen, also referred to as “asphalt binder”, is usually a liquid binder comprising asphaltenes, resins and solvents. Bitumen can for example comprise pyrogenous mixtures derived from petroleum residues such as residual oils, tar or pitch or mixtures thereof.

It is known in the art that sulphur can be mixed with bitumen for applications in the road construction and road paving industry. Sulphur-modified bitumen is formulated by replacing some of the bitumen in conventional binders by elemental sulphur. Sulphur-modified bitumen typically comprises a greater amount of sulphur than bitumen compositions in which sulphur is included as a crosslinking agent for polymer. EP 1498458 A1 uses sulphur as a crosslinking agent in an amount somewhat below 10 wt % based upon the weight of bitumen.

A problem that may be encountered during the production and paving of sulphur-containing asphalt, especially asphalt prepared using sulphur-modified bitumen, is eye and throat irritation. The present inventors have sought to reduce worker eye and throat irritation during the production and paving of sulphur-containing asphalt.

### SUMMARY OF THE INVENTION

The present inventors have found that eye and throat irritation can be caused by the presence of sulphur vapour. This realisation stems from an extensive study of possible causes and from eliminating more obvious other possibilities. Evaluation of industrial hygiene data from field trials of sulphur-modified bitumen indicated that hydrogen sulphide and sulphur dioxide levels (where found) were within legislative exposure limits and that their presence did not necessarily coincide with instances of worker discomfort.

It has been found that during a sulphur-asphalt mix preparation process, and while paving a road with sulphur-containing asphalt, the prevailing temperature may be high enough to lead to amounts of sulphur vapour that can cause eye and throat irritation to nearby workers. Sulphur sublimes easily and therefore generates relatively high amounts of sulphur vapour, even below the melting point of sulphur. The sulphur vapour that is in equilibrium above the hot asphalt mix will undergo deposition when in contact with a suitable surface.

Following identification of the prime source of eye and throat irritation, the present inventors have, through further research, found that by incorporating anionic surfactants into sulphur-containing asphalt it is possible to reduce the quantity of sulphur vapour encountered during production and paving and thereby decrease the amount of eye and throat irritation experienced by workers.

Accordingly, the present invention provides an asphalt composition comprising aggregate, bitumen, sulphur and an anionic surfactant, wherein the amount of anionic surfactant is from 0.05 wt % to 10 wt %, based upon the weight of the sulphur.

In another aspect, the present invention provides a process for manufacturing an asphalt composition according to the present invention, the process comprising the steps of:

(i) heating bitumen;
(ii) heating aggregate;
(iii) mixing the hot bitumen with the hot aggregate in a mixing unit to form an asphalt composition;
wherein sulphur is added in at least one of steps (i), (ii) or (iii); and wherein from 0.05 wt % to 10 wt % of anionic surfactant, based upon the weight of the sulphur, is added in at least one of the steps (i), (ii) or (iii) or is incorporated into the bitumen before step (i).

The invention further provides a process for preparing an asphalt pavement, wherein asphalt is prepared by a process according to the invention, and further comprising steps of:

(iv) spreading the asphalt into a layer; and
(v) compacting the layer.

In an embodiment of the invention, the sulphur and the anionic surfactant are added together; the sulphur is in the form of pellets and the anionic surfactant is incorporated in the sulphur pellets. Accordingly the invention further provides sulphur pellets comprising an anionic surfactant in an amount from 0.05 wt % to 10 wt %, based upon the weight of the sulphur. These pellets are advantageously used in a process according to the invention.

In another embodiment of the invention, the anionic surfactant is incorporated into the bitumen during or before step (i). Accordingly, the invention further provides a bitumen composition for use in preparing an asphalt composition comprising aggregate, bitumen and sulphur, the bitumen composition comprising bitumen and in the range of from 0.05 to 5.0 wt % of an anionic surfactant based on the total weight of the bitumen composition.

In an alternative embodiment of the invention, instead of incorporating the anionic surfactant into the asphalt composition, the anionic surfactant can be sprayed into the atmosphere as the asphalt pavement is laid. Accordingly, the present invention provides a process for preparing an asphalt pavement, the process comprising the steps of:

(i) heating bitumen;
(ii) heating aggregate;
(iii) mixing the hot bitumen with the hot aggregate in a mixing unit to form an asphalt composition;
(iv) spreading the asphalt composition into a layer; and
(v) compacting the layer;
wherein sulphur is added in at least one of steps (i), (ii) or (iii); and wherein, preferably from 0.05 wt % to 10 wt % based upon the weight of the sulphur, anionic surfactant, is sprayed above the layer in steps (iv) and/or (v). Such a process also reduces eye and throat irritation experienced by workers during preparation of an asphalt pavement.

The present invention also embraces the use of an anionic surfactant for the purpose of: (i) reducing the quantity of sulphur vapour encountered during the production and/or paving of an asphalt composition comprising aggregate, bitumen and sulphur; and/or (ii) for decreasing the amount of eye and throat irritation experienced by workers when paving an asphalt composition comprising aggregate, bitumen and sulphur. The use may comprise any of the methods described herein and/or may comprise incorporating sulphur pellets and/or a surfactant-containing bitumen composition described herein into a sulphur-containing asphalt composition.

### DETAILED DESCRIPTION OF THE INVENTION

The asphalt composition according to the invention comprises aggregate, bitumen, sulphur and an anionic surfactant.

The aggregate is suitably any aggregate that is suitable for road applications. The aggregate may comprise coarse aggregate (retained on a 4 mm sieve), fine aggregate (passes a 4 mm sieve but is retained on a 63 μm sieve) and/or filler (passes a 63 μm sieve).

Typically, the asphalt composition comprises at least 1 wt % of bitumen, based on the weight of the asphalt composition. An asphalt composition comprising from about 1 wt % to about 10 wt % of bitumen is preferred, with a special preference for asphalt compositions comprising from about 3 wt % to about 7 wt % of bitumen, based on the weight of the asphalt composition.

The bitumen can be selected from a wide range of bituminous compounds. The bitumen that can be employed may be straight run bitumen, thermally cracked residue or precipitation bitumen, e.g. from propane. Although not necessary, the bitumen may also have been subjected to blowing. The blowing may be carried out by treating the bitumen with an oxygen-containing gas, such as air, oxygen-enriched air, pure oxygen or any other gas that comprises molecular oxygen and an inert gas, such carbon dioxide or nitrogen. The blowing operation may be conducted at temperatures of 175 to 400° C., preferably from 200 to 350° C. Alternatively, the blowing treatment may be conducted by means of a catalytic process.

The bitumen for use herein is preferably a paving grade bitumen suitable for road application having a penetration of, for example, from 9 to 1000 dmm, more preferably of from 15 to 450 dmm (tested at 25° C. according to EN 1426: 1999) and a softening point of from 25 to 100° C., more preferably of from 25 to 60° C. (tested according to EN 1427: 1999).

The inventors encountered the problem of eye and throat irritation in the use of sulphur-modified bitumen/asphalt comprising substantial amounts of sulphur. Accordingly, advantageously, the asphalt may comprise, based on the weight of the bitumen, at least 10 wt % sulphur, preferably 20 wt % sulphur, more preferably at least 40 wt % sulphur.

The amount of sulphur in the asphalt composition is preferably from 10 to 200 wt %, based upon the weight of the bitumen, preferably from 20 wt %, more preferably from 40 wt % and preferably to 100 wt %, more preferably to 80 wt %. The presence of sulphur in the asphalt paving mixture can improve the strength and rutting resistance of the paving mixture and it is important to include sufficient sulphur to realise these advantages. Additionally, incorporating increased amounts of sulphur can decrease the cost of the paving mixture. However, too much sulphur can decrease the workability of the paving mixture.

The sulphur may be incorporated into the asphalt composition in the form of sulphur pellets. Reference herein to pellets is to any type of sulphur material that has been cast from the molten state into some kind of regularly sized particle, for example flakes, slates or sphere-shaped sulphur such as prills, granules, nuggets and pastilles or half pea sized sulphur. The sulphur pellets typically comprise from 50 to 100 wt % of sulphur, based upon the weight of the sulphur pellets, preferably from 60 wt % and most preferably from 70 wt %; and typically to 99 wt %, and preferably to 95 wt % or to 100 wt %. A more preferred range is from 60 to 100 wt %.

These sulphur pellets may contain carbon black and, optionally, other ingredients, such as amyl acetate and wax. Carbon black may be present in amounts up to 5% wt, based on the pellet, preferably up to 2% wt. Suitably, the content of carbon black in the sulphur pellet is at least 0.25% wt. The content of other ingredients, such as amyl acetate and wax, typically does not exceed an amount of 1.0% wt each. When wax is present, it may be in the form of, for example, slack wax or wax derived from a Fischer-Tropsch process. Examples of suitable waxes for use herein are Sasobit®, a Fischer-Tropsch derived wax commercially available from Sasol, and SX100 wax, a Fischer-Tropsch wax from Shell Malaysia.

An example of a suitable sulphur pellet for use herein is Thiopave® pellets commercially available from Shell Canada.

The anionic surfactant is suitably chosen from: the group consisting of lignin derivatives such as lignosulphonates; aromatic sulphonates and aliphatic sulphonates and their formaldehyde condensates and derivatives; fatty acids and carboxylates, including sulphonated fatty acids; and phosphate esters of alkylphenol-, polyalkylaryl- or alkyl-alkoxylates.

In a preferred embodiment, the anionic surfactant is a lignin derivative, more preferably a lignosulphonate. Lignosulphonates are known and are defined, for example, in Römpp Chemielexikon [Dictionary of Chemistry], 9th Edition, Volume 3, Georg-Thieme Verlag, Stuttgart, N.Y. 1990, page 2511. Particularly suitable lignosulphonates are the alkali metal salts and/or alkaline earth metal salts and/or ammonium salts, for example the ammonium, sodium, potassium, calcium or magnesium salts of lignosulphonic acid. The sodium, potassium or calcium salts are preferably used, and the sodium and/or calcium salts are most preferably used.

Lignosulphonates are derived from lignin, which is found in the cellular material of plants, e.g. trees.

Lignins comprise polymeric propylphenol substituted moieties which are interconnected at various positions on the carbon skeleton through a phenoxy group. Lignosulphonate may be produced from lignin by a sulphite process, in which suitable feedstock such as wood is digested at 140-170° C. with an aqueous solution of calcium bisulphite in acidic conditions. A benzylic cation is formed under the stated conditions, which is quenched by the sulphite ion to produce a sulphonated derivative which is separated.

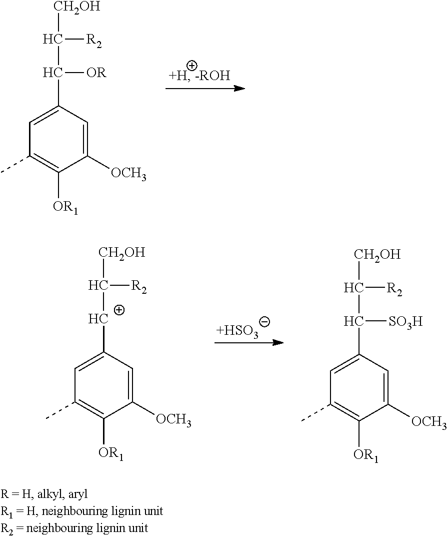

Details of this process are described, for example, in Monomers, Polymers and Composites from Renewable Resources; M. N. Belgacem, A. Gandini; Elsevier, 2008, 225-241.

Depending on the nature of the reaction conditions the lignosulphonate produced can contain carbohydrate components which are chemically linked to the lignosulphonate molecular framework. This material finds commercial applications as sugared lignosulphonate, which may for example have a carbohydrate content as high as 35 wt % depending on manufacturing conditions. Alcoholic fermentation of a sugared lignosulphonate mixture or selective chemical treatment by ultrafiltration can be used to remove sugar content to produce a de-sugared calcium lignosulphonate.

Lignosulphonates useful as anionic surfactants in the context of the invention may be sugared lignosulphonates or de-sugared lignosulphonates and may be derived from softwood or hardwood feedstocks.

For example, sugared lignosulphonates derived from hardwood and de-sugared lignosulphonates derived from softwood have been found to be of particular use.

Preferably, the carbohydrate content of the lignosulphonates, as determined by TAPPI test method T 249 cm-85 (involves an acid treatment followed by gas chromatography analysis), may be at most 35 wt %, more preferably at most 15 wt %, even more preferably at most 5 wt %.

In some embodiments of the invention, the lignosulphonates may have a sulphur content in the range of from 4 to 8 wt %, and/or a sulphur content in the +6 (sulphonate) oxidation state in the range of from 4 to 8 wt %. The molecular weight of the lignosulphonates may vary considerably and may lie, for example, in the range of from 7000 to 35000 Daltons, preferably 12,000 to 28,000 Daltons.

The term lignosulphonates also encompasses mixed salts of different ions such as potassium/sodium lignosulphonate, potassium/calcium lignosulphonate or the like, in particular sodium/calcium lignosulphonate.

In another embodiment, the anionic surfactant is an aromatic sulphonate. Examples of aromatic sulphonates are alkylnaphthalene sulphonates and condensates thereof; preferably the alkyl group contains 1 to 10 carbon atoms. Typical counter-ions are: proton, sodium, potassium, calcium, isopropropyl ammonium, ammonium, alkanolamine etc. Exemplary alkylnaphthalene sulfonates include metal salts and organic salts of alkylnaphthalene sulfonates such as sodium diisopropylnaphthalene sulfonate, butylnaphthalene sodium sulfonate, nonylnaphthalene sodium sulfonate, sodium dibutylnaphthalene sulfonate and sodium dimethylnaphthalene sulfonate.

Also, alkylbenzene sulphonates are preferred, in particular wherein the alkyl contains 1 to 20 carbon atoms, such as 1 to 12 carbon atoms. Suitable alkylbenzene sulphonates may be provided as a mixture of alkylbenzene sulphonates with a range of alkyl carbon atoms, preferably 10 to 16 carbon atoms, with the mean number of carbon atoms preferably being in the range of from 1 to 12. The alkylbenzene sulphonates may be linear or branched, with linear alkyl preferred for enhanced biodegradability. A particularly preferred alkylbenzene sulphonate is dodecyl benzene sulphonate, e.g. as its sodium salt.

Aliphatic sulphonates may, for example, be chosen from sulphonates of the formula R—SO₂—O—R′, wherein R is C₈-C₁₆ alkyl or alkenyl and R′ is a counter-ion selected from: proton, sodium, potassium, calcium, isopropropyl ammonium, ammonium, alkanolamine.

Fatty acids and carboxylates may, for example, be chosen from carboxylic compounds of formula RCOOH, wherein R is C₈-C₂₂ alkyl or alkenyl and optionally their carboxylates or salts. Preferably R is an alkyl group. It is preferred that R is a C₁₅-C₂₀ alkyl or alkenyl group, more preferably a C₁₅-C₁₈ alkyl or alkenyl group, and especially a C₁₅-C₁₈ alkyl group. For example, the fatty acid may be stearic acid. Alternatively, R may be a C₂₁-C₂₂ alkyl group, e.g. the carboxylic additive may be behenic acid. The fatty acids may be sulphonated.

Phosphate esters of alkylphenol-, polyalkylaryl- or alkyl-alkoxylates may, for example, be chosen to comprise in the range of from 1 to 30 carbon atoms, e.g. 5 to 25 carbon atoms or 10 to 20 carbon atoms.

The amount of anionic surfactant is from 0.05 wt % to 10 wt %, based upon the weight of the sulphur. Preferably the amount of anionic surfactant is from 0.1 to 8 wt %, more preferably from 0.2 to 5 wt % and most preferably from 0.7 to 3 wt %. Sufficient anionic surfactant should be incorporated to achieve the desired reduction in sulphur vapour and eye and throat irritation, but larger quantities will incur greater expense. For the avoidance of doubt, the “anionic surfactant” is described herein as a component which may comprise or consist of one or more of the anionic surfactant types or anionic surfactants mentioned herein. Preferably, the anionic surfactant may represent the entirety of anionic surfactant present in the relevant context, but this is not essential. For example, by way of illustration, in embodiments of the invention from 0.05 wt % to 10 wt % (or a preferred range as specified above) based upon the weight of the sulphur of an anionic surfactant comprising a sulphonate group, e.g. calcium lignosulphonate, may be present in an asphalt composition or pellet, with there being no limitation on the amount of other anionic surfactants present.

The anionic surfactant may be incorporated in a number of different forms, e.g. as a powder, a liquid, a solution in an aqueous solvent or a solution in an organic solvent such as glycol.

The asphalt composition of the invention may suitably comprise additional components. In one embodiment of the invention, the asphalt composition comprises a polymer. A preferred type of polymer is a copolymer comprising one or more vinyl aromatic compounds and one or more conjugated dienes, in an amount of 0.1 to 7% wt, based upon the weight of the asphalt composition. More preferably the polymer is a linear styrene-butadiene-styrene block copolymer of formula ABA wherein A is a polystyrene block and B is a polybutadiene block. Another preferred type of polymer is a copolymer formed from monomers including ethylene and glycidyl methacrylate or glycidyl acrylate, in an amount of 0.1 to 7% wt, based upon the weight of the asphalt composition. More preferably the polymer is a terpolymer formed from ethylene, alkyl acrylate and glycidyl methacrylate or glycidyl acrylate.

The asphalt composition may comprise an aminic compound selected from carbamides, thiocarbamides, carbamates and thiocarbamates, and mixtures thereof. The asphalt composition preferably comprises from 0.01 wt % to 10 wt % of the aminic compound. Preferred aminic compounds include urea, N,N′-(bishydroxymethyl)urea, N,N′-dimethyl urea, N,N′ trimethyl urea, 1,1-dimethyl urea, 1,3-diethyl urea, 1,3-dimethyl-1,3-diphenyl urea, benzyl urea, tert-butyl urea, phenyl urea, 1,3-diphenyl urea, 1,3-carbonyl dipiperidine, 1,3-dipropyl urea, 1,3-dibutyl urea, 1-[3-(trimethoxysilyl)propyl]urea, methyl carbamate, ethyl carbamate (also known as urethane), tert-butyl carbamate, phenyl carbamate and propyl carbamate.

In step (i) of the processes for manufacturing the present asphalt compositions the bitumen is heated, preferably at a temperature of from 60° C. to 200° C., preferably from 80 to 150° C., more preferably from 100° C. to 145° C., and even more preferably from 125° C. to 145° C. Working above 120° C. has the advantage that sulphur is liquid which facilitates the mixing process. Although the skilled person can easily determine the optimal mixing time the mixing time may be relatively short, e.g., from 10 to 600 seconds.

In step (ii) of the process for manufacturing the present asphalt composition the aggregate is heated, preferably at a temperature of from 60 to 200° C., preferably from 80 to 170° C., more preferably from 100 to 160° C., even more preferably from 100 to 145° C.

In step (iii) of the asphalt manufacturing process, the hot bitumen from step (i) and hot aggregate from step (ii) are mixed in a mixing unit. Suitably, the mixing takes place at a temperature of from 80 to 200° C., preferably from 90 to 150° C., more preferably from 100 to 145° C. Typically, the mixing time is from 10 to 60 seconds, preferably from 20 to 40 seconds.

Sulphur is preferably added as late as possible in the process, preferably in step (iii). Sulphur is preferably added in the form of pellets.

The sulphur and the anionic surfactant may be added together, i.e. both in step (i), step (ii) or step (iii). In a first embodiment, the hot aggregate is mixed with the sulphur and the anionic surfactant. Hot bitumen is then added to the hot aggregate-sulphur-anionic surfactant mixture. In a second embodiment, hot aggregate is mixed with hot bitumen, and the sulphur and the anionic surfactant are added to the hot bitumen-aggregate mixture. This embodiment offers the advantage of producing a stronger sulphur-asphalt mixture strength. In a third embodiment, hot bitumen is mixed with sulphur and the anionic surfactant and the resulting hot bitumen-sulphur-anionic surfactant mixture is mixed with hot aggregate to obtain a sulphur-comprising asphalt mixture.

Alternatively, in the asphalt manufacture process the anionic surfactant may be added separately. For example, the anionic surfactant may be added to the bitumen in step (i) and the sulphur may be added in step (iii).

In one embodiment of the invention, the sulphur and the anionic surfactant are added together; the sulphur is in the form of pellets and the anionic surfactant is incorporated in the sulphur pellets. The sulphur pellets preferably comprise from 0.05 to 10 wt % of the anionic surfactant, based upon the weight of the sulphur. The sulphur pellets are suitably prepared by a process wherein liquid sulphur is mixed with the anionic surfactant and optionally additional components such as carbon black and amyl acetate. The mixture is then shaped and/or pelletised.

In one embodiment of the invention sulphur may be added in the form of two types of sulphur pellets; a first type of sulphur pellet that comprises the anionic surfactant and a second type of sulphur pellet that does not comprise the anionic surfactant. This has the advantage that the anionic surfactant is essentially concentrated in the first type of sulphur pellet and conventional sulphur pellets can be used to make up the rest of the sulphur requirement.

In one embodiment of the invention the anionic surfactant is added to the bitumen before step (i). The anionic surfactant is thus pre-incorporated into the bitumen to form a bitumen composition by heating the bitumen, e.g. to a temperature of from 60° C. to 200° C., preferably from 80 to 150° C., more preferably from 100° C. to 145° C., and even more preferably from 125° C. to 145° C., and mixing it with the anionic surfactant. The bitumen composition may be stored at its heated temperature before being used for manufacturing the present asphalt compositions. The bitumen composition may for example be stored for at least 12, 24, 36 or 48, e.g. up to 72 or 96 hours. Conveniently, the anionic surfactant content of the bitumen composition may be adjusted to be in the range of from 0.05 to 5.0 wt %, based on the total weight of the bitumen composition.

The invention further provides a process for preparing an asphalt pavement, wherein asphalt is prepared by a process according to the invention, and further comprising steps of:

(iv) spreading the asphalt into a layer; and
(v) compacting the layer.

The invention further provides an asphalt pavement prepared by the process according to the invention.

The compaction in step (v) suitably takes place at a temperature of from 80 to 200° C., preferably from 90 to 150° C., more preferably from 100 to 145° C. The temperature of compaction is desirably kept as low as possible in order to reduce hydrogen sulphide emissions. However, the temperature of compaction needs to be sufficiently high such that the voids content of the resulting asphalt is sufficiently low for the asphalt to be durable and water resistant.

In an alternative embodiment, the present invention provides a process for preparing an asphalt pavement, the process comprising the steps of:

(i) heating bitumen;
(ii) heating aggregate;
(iii) mixing the hot bitumen with the hot aggregate in a mixing unit to form an asphalt composition;
(iv) spreading the asphalt composition into a layer; and
(v) compacting the layer;
wherein sulphur is added in at least one of steps (i), (ii) or (iii); and wherein from 0.05 wt % to 10 wt % of anionic surfactant, based upon the weight of the sulphur, is sprayed above the layer in steps (iv) and/or (v). The preferred formulations and conditions for the process, including the preferred anionic surfactant, are substantially as described above. Spraying the anionic surfactant into the atmosphere above the layer can be accomplished by any suitable means. The surfactant is preferably used as an aqueous solution, or may alternatively be used as a solution in an organic solvent.

The invention will now be illustrated by means of the following Examples, which are not intended to limit the invention.

### Example 1

A blend of elemental sulphur and bitumen was heated to 145-148° C. The bitumen was a 60/70 penetration grade bitumen and the weight ratio of sulphur:bitumen was 30:70. A lignosulphonate additive was added while the stirring was continued for 3 hours. Evaporated sulphur was collected on a filter paper for 3 hours and its weight was measured gravimetrically to determine the sulphur loss.

In more detail, Bitumen of 60/70 penetration grade was pre-heated in an oven for 1 hour at 145° C. To a stainless steel beaker (125 mL, without a lip on the neck) was added the pre-heated bitumen (47 g) and elemental sulphur granules (20 g) ensuring that the bitumen:sulphur ratio was 70:30. This was followed by addition of the lignosulphonate additive in the amount specified in Table 1. The vessel was placed in an insulated heating jacket and heated using a Heidolph magnetic hot plate and stirred using a magnetic needle (0.5″ cross shape) at a constant speed of 650 rpm with the temperature maintained at 145-148° C. To condense and collect the sulphur vapour, the reaction vessel was covered with a pre-weighed filter paper (Whatman filter paper: cat no: 1005, 150), petridish and a beaker filled with ice/water which was maintained throughout the duration of the experiment. After 3 h, the equipment was cooled to ambient temperature and the sulphur collected on the filter paper was assessed by gravimetric analysis. For each experimental variable, the procedure was repeated three times and the average result taken.

This was compared with a control experiment with no additive to measure % sulphur loss.

It was observed that sulphur loss varied between control experiments; this may have been due to inhomogeneous stirring or bitumen aging effects. To ensure that an accurate comparison could be made between experimental examples and control examples, a control example was carried out alongside each experimental example.

Three different lignosulphonate additives were used: Additive 1 was Flambinder NX, a calcium lignosulphonate aqueous solution available from Flambeau River Papers LLC, USA; Additive 2 was Marasperse CBOS-4, a calcium lignosulphonate powder available from Lignotech, USA; and Additive 3 was Borresperse NA, a sodium lignosulphonate powder available from Borregaard Lignotech USA. Additive amounts are reported as weight percentages, based upon the weight of the sulphur, wherein the weight is the weight of the solid lignosulphonate (i.e. the weight of any solvent is not included).

Results are shown in Table 1:

TABLE 1

| | Additive (wt % based | Sulphur loss | Sulphur loss for same- | Sulphur |
|---|---|---|---|---|
| | upon weight of S) | (ppmw) | day control (pmw) | reduction (%) |
| Experiment 1 | 0.8 wt % Additive 1 | 345 | 565 | 39 |
| Experiment 2 | 0.17 wt % Additive 1 | 645 | 555 | −16 |
| Experiment 3* | 0.8 wt % Additive 1 | 427 | 1400 | 70 |
| Experiment 4 | 1.5 wt % Additive 2 | 582 | 1510 | 61 |
| Experiment 5 | 1 wt % Additive 3 | 712 | 1800 | 60 |
| Experiment 6 | 1.5 wt % Additive 3 | 677 | 1820 | 63 |
| Experiment 7 | 2 wt % Additive 3 | 660 | 1785 | 63 |
| Experiment 8 | 3 wt % Additive 3 | 660 | 1860 | 65 |

*In Experiment 3 the lignosulphonate additive was pre-blended with the bitumen before the sulphur was mixed with the bitumen.

Even though the experiments do not relate to asphalt compositions of the invention (the experimental blends comprise bitumen, sulphur and anionic surfactant but no aggregate), the inventors believe that the results demonstrate a significant reduction in elemental sulphur vapour which would also be experienced when blending bitumen, sulphur, aggregate and anionic surfactant. All the experiments showed a significant reduction in sulphur vapour (from 39 to 70 wt %) except for the experiment wherein the smallest amount of surfactant was employed (experiment 2, wherein only 0.17 wt % of surfactant was used).

### Example 2

The procedure of Example 1 was repeated with other surfactants in turn as additives instead of lignosulphonate additive.

Additive 4 was sodium dodecyl benzene sulphonate (DDBSA) available from Merck; Additive 5 was stearic acid; and Additive 6 was Toximul TA-5®, a tallow amine ethoxylate available from Stepan.

The amount of additive was 1.5 wt % in each case, based upon the weight of the sulphur. For each experimental variable, the procedure was repeated three times and the average result taken. Results are shown in Table 2:

TABLE 2

| | Additive (1.5 wt % | Sulphur reduction |
|---|---|---|
| | based on wt of S) | (%) |
| Experiment 9 | Additive 4 | 51 |
| Experiment 10 | Additive 5 | 35 |
| Experiment 11 | Additive 6 | 31 |

Even though the experiments do not relate to asphalt compositions of the invention (the experimental blends comprise bitumen, sulphur and surfactant but no aggregate), the inventors believe that the results shown by anionic surfactants demonstrate a significant reduction in elemental sulphur vapour which would also be experienced when blending bitumen, sulphur, aggregate and anionic surfactant. The results demonstrate that alkylbenzene sulphonates and fatty acids are of use in achieving a significant reduction in elemental sulphur vapour.

### Example 3

The storage stability of a bitumen composition comprising an anionic surfactant was investigated. The bitumen composition was prepared by pre-blending a VG30 (60/70 grade) paving grade bitumen (47 g) with calcium lignosulphonate in the form of powder (1.5 wt % concentration with respect to final sulphur content in use) (300 mg) at a temperature of 150-155° C. The bitumen composition was stored at 140-145° C. for the time shown in Table 3 below prior to testing sulphur reduction in accordance with the procedure of Example 1.

Results are shown in Table 3:

TABLE 3

| Storage Time (hours) | Sulphur Reduction (%) |
|---|---|
| 0 | 57 |
| 12 | 56 |
| 24 | 52 |
| 48 | 55 |
| 72 | 46 |

The results show that whilst a drop off in performance was noticeable after 48 hours, even the sulphur reduction achieved after storing the bitumen composition for 72 hours (46%) would still represent a significant lowering of sulphur vapour in a sulphur-bitumen mixture.

1. An asphalt composition comprising aggregate, bitumen, sulphur and an anionic surfactant, wherein the amount of anionic surfactant is from 0.05 wt % to 10 wt %, based upon the weight of the sulphur.

2. An asphalt composition according to claim 1, comprising from 1 wt % to 10 wt % of bitumen, based on the weight of the asphalt composition.

3. An asphalt composition according to claim 1, wherein the amount of sulphur is from 10 to 200 wt %, based upon the weight of the bitumen.

4. An asphalt composition according to claim 1, wherein the anionic surfactant is chosen from the group consisting of lignin derivatives; aromatic sulphonates and aliphatic sulphonates and their formaldehyde condensates and derivatives; fatty acids and carboxylates; and phosphate esters of alkylphenol-, polyalkylaryl- or alkyl-alkoxylates.

5. An asphalt composition according to claim 4, wherein the anionic surfactant is a lignosulphonate.

6. A process for manufacturing an asphalt composition according to claim 1, the process comprising the steps of:
(i) heating bitumen;
(ii) heating aggregate;
(iii) mixing the hot bitumen with the hot aggregate in a mixing unit to form an asphalt composition;
wherein sulphur is added in at least one of steps (i), (ii) or (iii); and wherein from 0.05 wt % to 10 wt % of anionic surfactant, based upon the weight of the sulphur, is added in at least one of the steps (i), (ii) or (iii).

7. A process for manufacturing an asphalt composition according to claim 6, wherein sulphur is added in the form of pellets.

8. A process for manufacturing an asphalt composition according to claim 7, wherein the sulphur pellets and the anionic surfactant are added together and the anionic surfactant is incorporated in the sulphur pellets.

9. A process for preparing an asphalt pavement, wherein an asphalt composition is prepared by a process according to any one of claim 6, and further comprising steps of:
(iv) spreading the asphalt into a layer; and
(v) compacting the layer.

10. Sulphur pellet comprising an anionic surfactant in an amount from 0.05 wt % to 10 wt %, based upon the weight of the sulphur.

11. Sulphur pellet according to claim 10 wherein the anionic surfactant is a lignin derivative.

12. Sulphur pellet according to claim 10 wherein the anionic surfactant is a lignosulphonate.

13. A process for preparing an asphalt pavement, the process comprising the steps of:
(i) heating bitumen;
(ii) heating aggregate;
(iii) mixing the hot bitumen with the hot aggregate in a mixing unit to form an asphalt composition;
(iv) spreading the asphalt composition into a layer; and
(v) compacting the layer;
wherein sulphur is added in at least one of steps (i), (ii) or (iii); and wherein anionic surfactant is sprayed above the layer in steps (iv) and/or (v).

14. A process according to claim 13 wherein from 0.05 wt % to 10 wt % of the anionic surfactant, based upon the weight of the sulphur, is sprayed above the layer in steps (iv) and/or (v).

15. An asphalt composition according to claim 2, wherein the anionic surfactant is chosen from the group consisting of lignin derivatives; aromatic sulphonates and aliphatic sulphonates and their formaldehyde condensates and derivatives; fatty acids and carboxylates; and phosphate esters of alkylphenol-, polyalkylaryl- or alkyl-alkoxylates.

16. An asphalt composition according to claim 3, wherein the anionic surfactant is chosen from the group consisting of lignin derivatives; aromatic sulphonates and aliphatic sulphonates and their formaldehyde condensates and derivatives; fatty acids and carboxylates; and phosphate esters of alkylphenol-, polyalkylaryl- or alkyl-alkoxylates.

17. A process for manufacturing an asphalt composition according to claim 2, the process comprising the steps of:
(i) heating bitumen;
(ii) heating aggregate;
(iii) mixing the hot bitumen with the hot aggregate in a mixing unit to form an asphalt composition;
wherein sulphur is added in at least one of steps (i), (ii) or (iii); and wherein from 0.05 wt % to 10 wt % of anionic surfactant, based upon the weight of the sulphur, is added in at least one of the steps (i), (ii) or (iii).

18. A process for manufacturing an asphalt composition according to claim 3, the process comprising the steps of:
(i) heating bitumen;
(ii) heating aggregate;
(iv) mixing the hot bitumen with the hot aggregate in a mixing unit to form an asphalt composition;
wherein sulphur is added in at least one of steps (i), (ii) or (iii); and wherein from 0.05 wt % to 10 wt % of anionic surfactant, based upon the weight of the sulphur, is added in at least one of the steps (i), (ii) or (iii).

19. A process for manufacturing an asphalt composition according to claim 4, the process comprising the steps of:
(i) heating bitumen;
(ii) heating aggregate;
(v) mixing the hot bitumen with the hot aggregate in a mixing unit to form an asphalt composition;
wherein sulphur is added in at least one of steps (i), (ii) or (iii); and wherein from 0.05 wt % to 10 wt % of anionic surfactant, based upon the weight of the sulphur, is added in at least one of the steps (i), (ii) or (iii).

20. A process for manufacturing an asphalt composition according to claim 5, the process comprising the steps of:
(i) heating bitumen;
(ii) heating aggregate;
(vi) mixing the hot bitumen with the hot aggregate in a mixing unit to form an asphalt composition;
wherein sulphur is added in at least one of steps (i), (ii) or (iii); and wherein from 0.05 wt % to 10 wt % of anionic surfactant, based upon the weight of the sulphur, is added in at least one of the steps (i), (ii) or (iii).
